(19) United States
(12) Patent Application Publication
(10) Pub. No.: US 2001/0029459 A1
(43) Pub. Date: Oct. 11, 2001

(54) Travel information provided center, travel information provided terminal, and travel information provided system

(75) Inventor: Yasuhisa Fujiwara, Nishikamo-gun (JP)

Correspondence Address: OLIFF & BERRIDGE, PLC, 277 S. WASHINGTON STREET, SUITE 500, ALEXANDRIA, VA, 22314, US

(73) Assignee: TOYOTA JIDOSHA KABUSHIKI KAISHA

(21) Appl. No.: 09/822,349

(22) Filed: Apr. 2, 2001

(30) Foreign Application Priority Data
Apr. 10, 2000 (JP) 2000-108673

(51) Int. Cl. G06F 17/60

(52) U.S. Cl. 705/6

(57) ABSTRACT

The invention relates to a travel information center which provides travel information upon a user request. In order to confirm the user is a registered user, a controller will require a search of a memory database, located in the travel information center, and confirm the users identification number entered by the user. Upon confirmation, the member can access the travel information center. The user is now able to input starting and ending locations for their course of travel. The travel information center will then provide information such as the shortest or quickest route to arrive at the desired destination. Other information can be obtained by the user through the travel information center that will be useful to the members along the travel route, such as shopping malls and restaurant locations.

### INCORPORATION BY REFERENCE

The disclosure of Japanese Patent Application No. 2000-108673 filed on Apr. 10, 2000 including the specification, drawings and abstract is incorporated herein by reference in its entirety.

### BACKGROUND OF THE INVENTION

1. Field of Invention

The invention relates to a travel information providing center for providing user terminals with travel information, an information providing terminal for providing users with travel information, and a travel information providing system for providing users with travel information.

2. Description of Related Art

In the present day, various information providing services are widely available, including services for providing travel information. In particular, various pieces of travel information can be obtained by using a communication system such as the internet.

An on-vehicle navigation system is also widely available. Upon inputting a destination, this system searches for a route to the destination. Once the route has been set, the system provides route guidance whenever it is considered necessary during traveling.

Furthermore, it is known to have an on-vehicle communication terminal which is connected through an information providing server and a communication line, which can obtain information on a route and facilities from the information providing server.

As for information that can be obtained or made only at a high cost and with enormous labor, there is a demand that the information be sold. In such a case, a system that provides a user with information, as soon as it is confirmed that the user is one of pre-registered members, is convenient. The information exclusively available to the members, can be provided to them quickly and efficiently.

When a member is registered, certain information about the member is stored. It is desirable to make special arrangements to meet the convenience of registered members not only by providing them with information but also by offering them articles. The effective provision of information on such services is also desired.

Furthermore, if an information providing terminal is installed in, for example, a convenience store or the like to provide information, even a user who does not have a personal computer can receive information providing services. Information on spots where such information providing terminals are installed can be registered in a center. Accordingly, the efficient provision of services based on information characteristic of the information providing terminals is also desired.

### SUMMARY OF THE INVENTION

The invention has been made in consideration of the aforementioned circumstances. It is an object of the invention to provide a travel information providing center, a travel information providing terminal and a travel information providing system capable of efficiently providing users with travel information and the like.

Upon confirmation of a registered member based on member information that has been sent, a travel information providing center according to a first aspect of the invention makes travel information available using information on the registered member. In this manner, travel information is provided using information on pre-registered members. In contrast to when travel information is provided with no information on members, now it is possible to provide users with information better suited to their needs.

Upon confirmation of a registered member based on member information that has been sent through a terminal, a travel information providing center according to a second aspect of the invention provides information on the locations of pre-registered information providing terminals which are located adjacent to a route to be provided. The information providing terminals can provide the members with various pieces of information. If a user is advised of the location of an information providing terminal which is installed in, for example, a convenience store or the like, and which is located near the route, the user can easily access the center when needed, and obtain the information he or she wants.

Upon confirmation of a registered member based on member information that has been sent through a user terminal, a travel information providing center according to a third aspect of the invention provides information on the locations of service providing facilities which are exclusively available to members and which are located adjacent to a route to be provided. The members are interested in information on facilities providing them with special services. It is therefore possible to provide information matching users' tastes.

As soon as it is confirmed that the input member information refers to a registered member, an information providing terminal according to an aspect of the invention provides detailed information on the neighborhood of the terminal. Because the information providing terminal is permanently installed in a store or the like, information on the neighborhood of the store or the like is often requested. The information providing terminal stores detailed information on its neighborhood in advance and provides users with the information so as to meet their needs. For example, it is possible to provide detailed map data regarding the neighborhood, discount information, and the like.

An information providing terminal according to another aspect of the invention, prepares a junction guidance map showing junctions that require guidance from route information to be provided and prints the prepared junction guidance map. In actual driving situations, a user needs information on junctions. Provided with a sheet on which required information is printed, the user can put it in his or her own car and refer to it whenever necessary.

A travel information providing system according to one embodiment of the invention comprises a terminal through which a user inputs a member ID and a center which provides a registered member with travel information based on member information as soon as the user is judged to be a registered member.

### BRIEF DESCRIPTION OF THE DRAWINGS

The invention will be described in conjunction with the following drawings in which like reference numerals designate like elements and wherein:

FIG. 1 is a block diagram of the structure of an embodiment of the invention;

FIG. 2 is a flowchart showing the search for a route when a starting point is determined;

FIG. 3 is a flowchart showing the provision of the information on facilities in consideration of the tastes of members;

FIG. 4 is a flowchart showing the provision of the information on accommodation facilities in consideration of the tastes of members;

FIG. 5 is a flowchart showing the process of providing information during traveling;

FIG. 6 is a flowchart showing the provision of the information on a neighborhood;

FIG. 7 is a flowchart showing the provision of the information on services exclusively available to members;

FIG. 8 shows an example of the indication of an entire route; and

FIG. 9 shows a printing example of a rally map.

### DETAILED DESCRIPTION OF PREFERRED EMBODIMENTS

Hereinafter, an embodiment of the invention will be described with reference to the drawings.

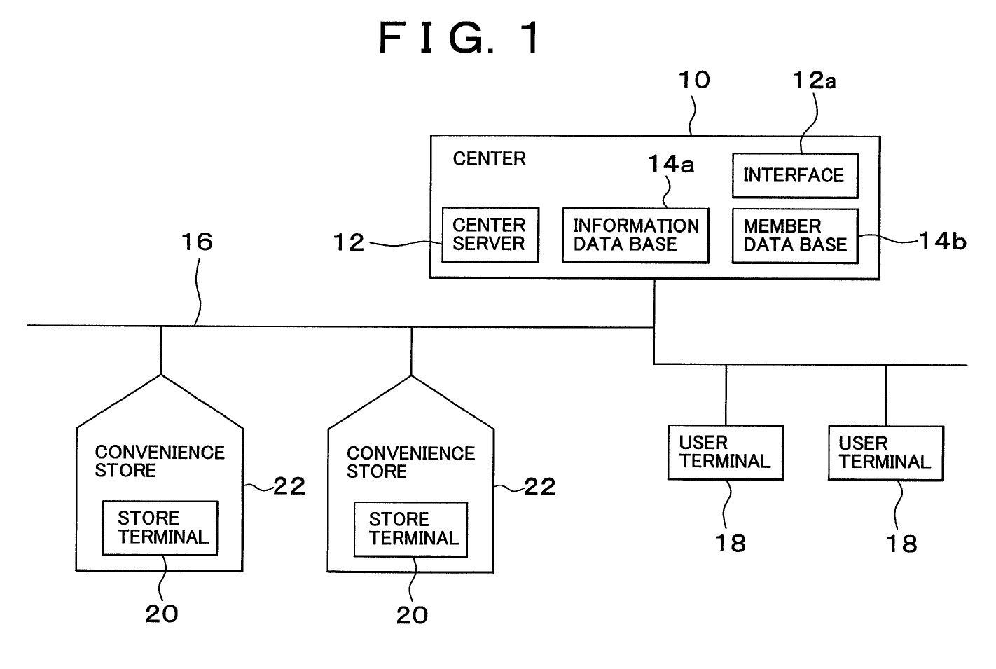

FIG. 1 shows an information providing system according to one embodiment of the invention. The information providing system includes an information providing server (center server) and an information providing terminal (store terminal).

A center 10 includes a center server 12 and databases. Using the center server 12, the center 10 provides services such as the provision of information and the distribution of articles. The databases include an information database 14a and a member database 14b. The information database 14a stores various pieces of information such as the information on travel and articles for sale. The member database 14b stores the information on pre-registered members. The information on the members includes their names, home addresses, age, sex, credit card numbers and the like. The information is stored in conjunction with the registration numbers allocated to the members.

A communication network 16 is connected to the center server 12 of the center 10. The center server 12 exchanges various pieces of information through the communication network 16. For example, the center server 12 periodically gathers information from an external information source and updates the contents stored in the information database 14a. When the necessity arises, the information providing server 12 accesses other information centers and the like, through the communication network 16 and obtains required data.

Furthermore, a plurality of user terminals 18 are connected to the communication network 16. The user terminals 18, which are computers possessed by users, are connected to the center server 12 through the communication line 16 leading to their homes, offices and the like. Using the user terminals 18, the users can receive various services provided by the center server 12. The user terminals 18 may also be designed as an on-vehicle terminal or a portable terminal.

A plurality of store terminals 20 are connected to the communication network 16. The store terminals 20, which are computers installed in stores such as, for example, convenience stores, gas stations, and the like, as well as other stores, for example, road side rest stops or restaurants are operated by users who visit the stores. By operating the store terminals 20, the users can receive various services such as the purchase of articles and the acquisition of information from the center server 12.

In this system, users are registered for membership and many services are exclusively available to the registered members. This registration is carried out using the user terminals 18 and the store terminals 20. For example, if a user inputs user information such as his or her name, home address, age, sex and credit card number, the center server 12 allocates a unique registration number to the user and advises him or her of the registration number. The center server 12 then stores the information on the user into the member database 14b in conjunction with the registration number.

Although the center 10 sells articles as described above, the provision of the information on traveling routes will now be described.

A user operates either a user terminal 18 or a store terminal 20 to establish a connection with the center server 12. In the case where a user terminal 18 is used, the communication network 16 can be for example, the internet, and usually establishes a connection with the center server 12 through the internet which necessitates a public telephone line and a provider. In the case where a store terminal 20 is used, it is preferable to use private lines.

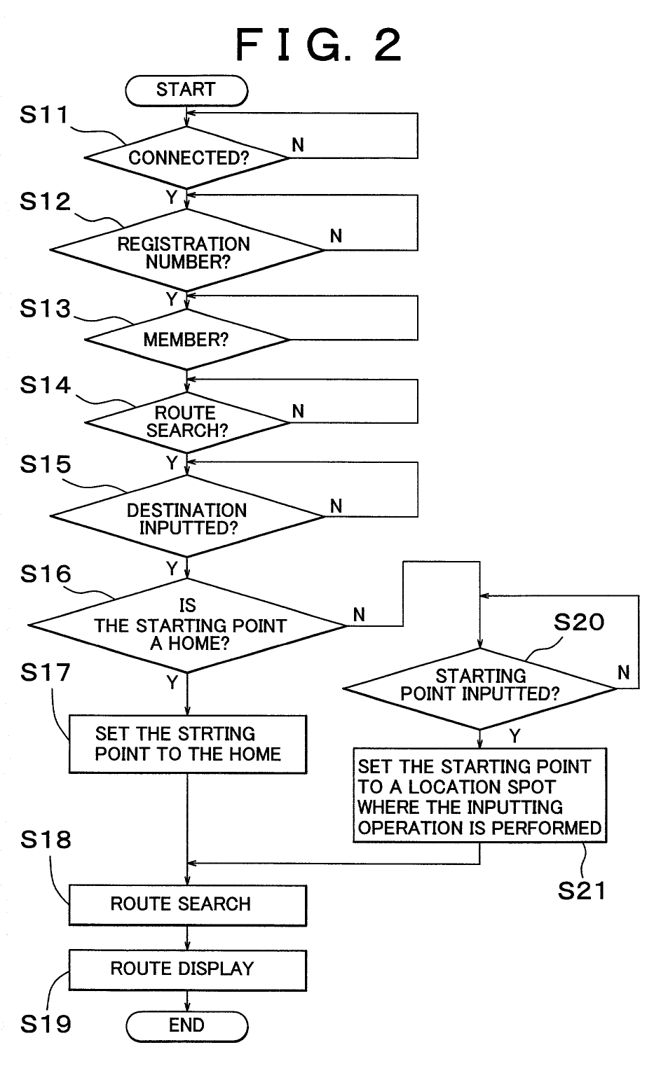

The actions performed by the center server 12 in this case will be described with reference to FIG. 2. The center server 12 judges whether or not a connection with a terminal has been established (S11). If the connection has been established, the center server 12 judges whether or not a registration number has been input (S12). Either the center server 12 or the terminal (the user terminal 18 or the store terminal 20) can request the input of the registration number. If the registration number has been input, the center server 12 gathers the registration number and judges from the contents stored in the member database 14b whether or not the user is a pre-registered member (S13).

If the judgment result confirms that the user is the member, the center server 12 posts a menu of available services and waits for the user to make a selection. Because the case of this embodiment handles the provision of traveling routes, the center server 12 judges whether or not travel information has been selected. If the travel information has been selected, the center server 12 displays menus regarding the search for a route to be traveled by a vehicle, the search for a traveling method using public transportation, and the search for a destination suited for the user's purpose. The center server 12 then waits for the user to input data. The center server 12 then judges whether or not the search for a route to a destination has been selected (S14). If YES, the center server 12 requests the user to input a destination. In this case, the destination can be input using place-names, an area code, a telephone number, a postal code, maps and the like.

The center server 12 judges whether or not the destination has been input (S15). If the destination has been input, the center server 12 inquires of the user whether or not the starting point can be set as his or her home (S16). Namely, the member database 14b stores the home addresses of the users as the information on the members. Thus, the user can automatically set his or her home address as the starting point of travel. Because the starting point of travel coincides with the user's home address in many cases, the inputting operation can be simplified.

If the answer to the inquiry about whether or not the starting point can be set as the home address is YES, the center server 12 sets the starting point as the home address (S17), searches for a route to the destination from the starting point set as the home address (S18), and displays the result of the search (S19).

It is possible to display the result of the search in the form of the entire route from the starting point to the destination or essential spots on the map. For example, a screen for displaying the essential spots, displays one guidance intersection for making a right or left turn after another on an enlarged scale, and displays a plurality of guidance intersections.

If the result of the judgment in S16 is NO, the center server 12 requests the user to input a starting point and judges whether or not the starting point has been input (S20). If the starting point has been input, the center server 12 sets the starting point to an input point (S21) and searches for a route in S18.

In addition, the member database 14b of the center 10 often stores the purchase records of the member and the data regarding his or her taste. In this case, the center server 12 searches for facilities and tourist spots in the neighborhood (i.e., in the vicinity) of the destination or the route that might interest the member, based on the stored data regarding the member.

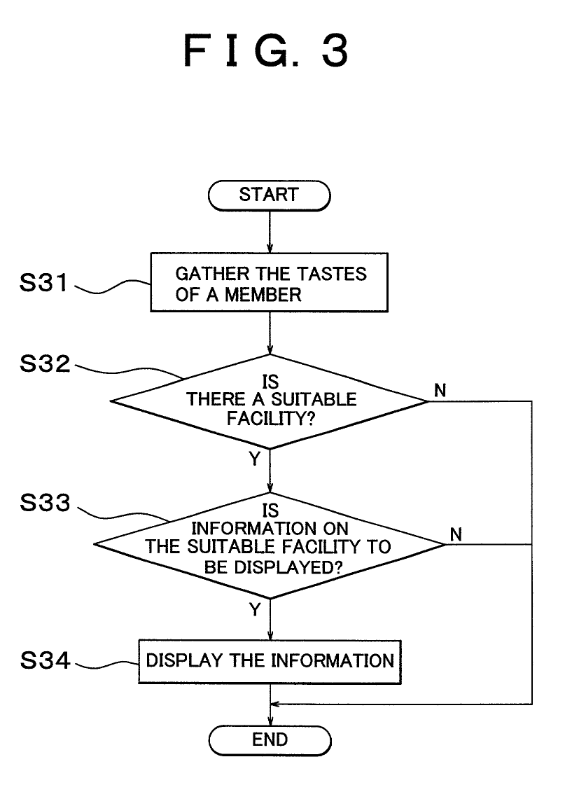

As shown in FIG. 3, the center server 12 first of all gathers the information on the taste of the member from the member database 14b (S31). The center server 12 then judges whether or not there is a facility that matches the taste in the neighborhood of the route (S32). If the result of the judgment in S32 is YES, the center server 12 inquires of the member whether or not to display the information on the facility (S33). If the member has given a YES response, the center server 12 displays the information (S34).

For example, if the registered member is interested in paintings, the center server 12 searches for museums along the route or at the destination and outputs a message “There are * number of museums in the neighborhood of the destination and the route. Would you like to have the information on the museums displayed?”. If the member has input YES, the center server 12 outputs the detailed information.

Before displaying the aforementioned route, the center server 12 may inquire of the member whether or not to provide the information matching his or her taste.

It is also possible to introduce (identify) various stores (stores selling articles, restaurants, and the like) which accord the members registered in the center 10 a special reduction.

Furthermore, if there is a request for accommodation from a member, the center server 12 provides the information on accommodation facilities. In this case, the center server 12 also introduces accommodation facilities in consideration of the member's taste, based on the pre-registered information on the member. For example, if the facilities selected by the member in the past are in the deluxe class, the center server 12 introduces deluxe-class facilities by the first priority and economy-class facilities by the second priority. At the request of the member, the information is provided according to priority.

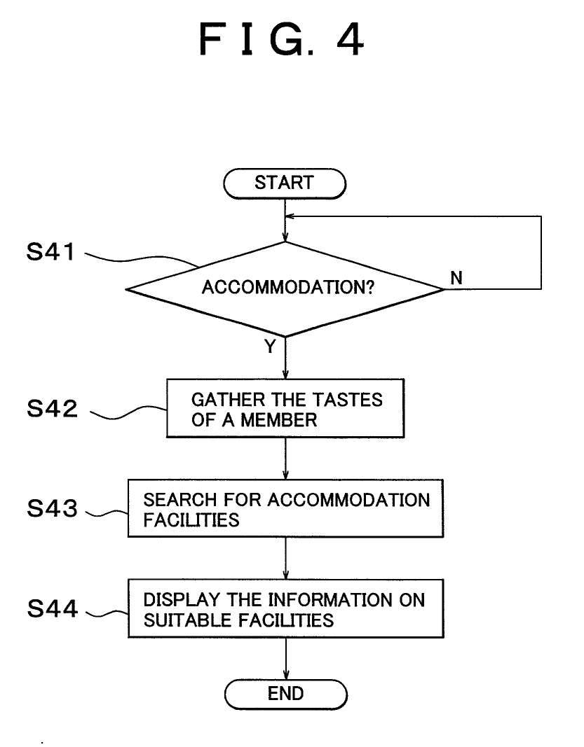

For example, as shown in FIG. 4, the center server 12 judges whether or not there is a request for an accommodation facility at the destination or the like (S41). If YES, the center server 12 gathers the member's taste from the member database 14b (S42). The center server 12 then searches for an accommodation facility in the neighborhood of the destination (S43) and displays the information on accommodation facilities as a search result (S44). The search and tabulation are conducted in consideration of the member's taste.

Furthermore, the center server 12 displays buttons for searching for the information on “restaurants”, “filling stations”, “rest rooms”, “convenience stores” and the like as soon as it displays the route. If they are operated, the center server 12 provides the information on those facilities in the neighborhood of the destination and the route. It is also preferable to select relevant facilities in consideration of the traveling time. In particular, it is possible to urge the member to input a starting time and provide the information on restaurants in a region the member is supposed to pass at the mealtime, based on the starting time.

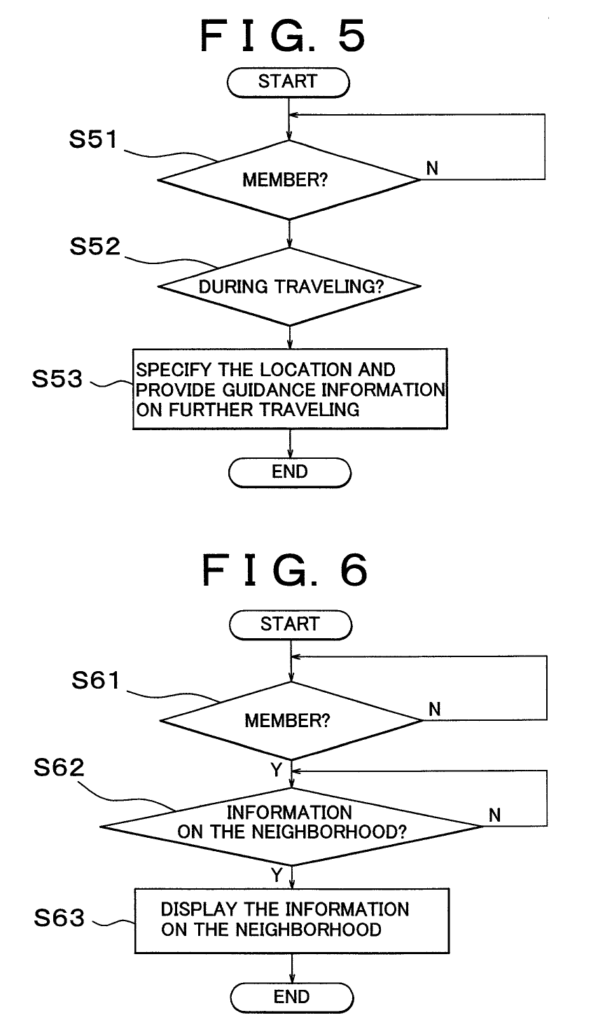

In this embodiment, the store terminals 20 through which users can receive services offered by the center 10 are installed at various locations. Thus, the center server 12 identifies installation locations of the store terminals 20 as soon as it displays the route. If a user has visited, for example, a store that has been identified to him or her during traveling and operated the store terminal 20, the center server 12 first of all requests the user to input his or her registration number as shown in FIG. 5. If the user has input his or her registration number, the center server 12 judges from the registration number whether or not the user is a member (S51). If the user is the member, the center server 12 then judges whether or not the user is in the course of traveling (S52). If the user is in the course of traveling, the center server 12 reads out data regarding the user and data regarding the traveling, and locates the store terminal 20 that is being operated. If the user is on the route, the center server 12 memorizes that the user has arrived where he or she is, and outputs a guidance of further traveling to the user (S53).

For example, if the user is traveling as initially planned, the center server 12 advises the user accordingly, and how much travel time remains. On the other hand, if the user is not traveling as initially planned, the center server 12 advises the user accordingly. For example, the center server 12 advises the user that he or she is taking a different route, or that he or she is not on schedule, and of the influences resulting therefrom.

The store terminal 20 stores in itself the information characteristic of the neighborhood of its installation location, such as the information on local events which need not be stored in the center 10. Moreover, the store terminal 20 also stores the minutely detailed map information on the neighborhood of its installation location.

Thus, as shown in FIG. 6, the center server 12 judges whether or not the user is a member (S61). If the user is a member, the center server 12 inquires of the user whether or not he or she needs the detailed information on the neighborhood (S62). If YES, the center server 12 provides him or her with the detailed information (S63).

For example, as soon as the user operates the store terminal 20, the center server 12 inquires of the user whether or not he or she needs the information on events. If YES, the center server 12 provides the user with the information that bread fresh from the oven is available at a bakery in the neighborhood, that a display of fireworks will take place in ten minutes, that a Japanese restaurant in the neighborhood serves excellent Japanese cuisine, and the like. In addition, the center server 12 displays a detailed route to the destination based on a detailed map. Furthermore, it is also preferable to display the pictures of essential locations, animation, and the like.

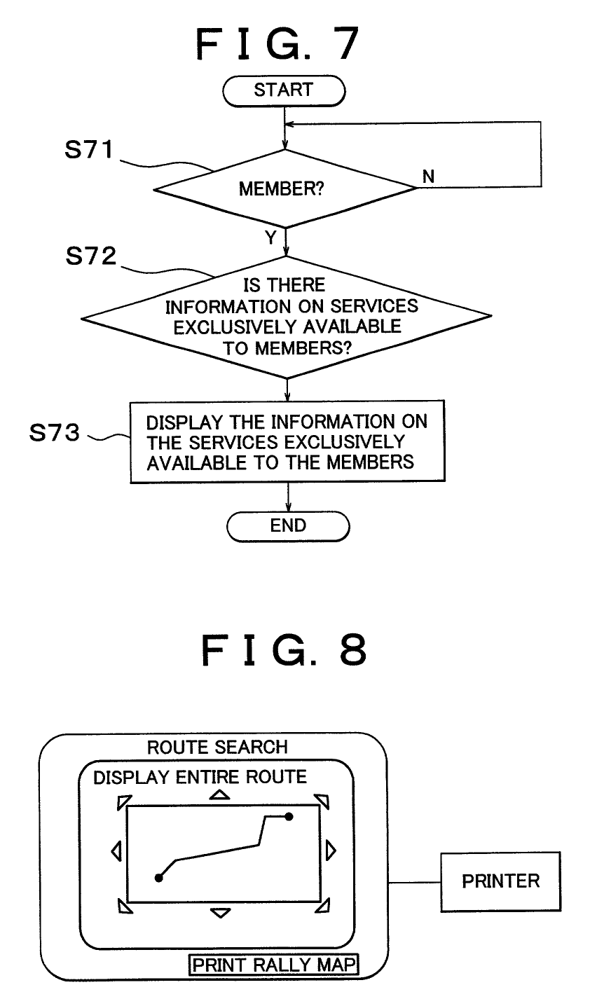

For example, as shown in FIG. 7, the center server 12 judges whether or not the user is a member (S71). If the user is a member, the center server 12 judges whether or not there is any service information exclusively available to members (S72). If there is service information, the center server 12 displays them and provides the user with them (S73).

It is also preferable to introduce various stores (stores selling articles, restaurants, and the like) which accord the members registered in the center 10 a special reduction and which are located in a region where the store terminal 20 that is being operated, is installed. Because the region is not extensive (large), it is possible to easily provide the information on facilities users can utilize easily.

Whether or not a user is in the course of traveling, it is also possible to obtain travel information from one of the store terminals 20. The operation in this case is basically identical to the operation in the case where the user terminals 18 are used. However, it is preferable that the store terminal 20 output a route guidance map using a printer for issuing receipts. That is, if the user connects the store terminal 20 to the center 10 and inputs his or her destination by touch screen, mouse, or any other known or later-developed method, the center 10 searches for a route, so that the search result is sent to the store terminal 20.

The store terminal 20 then displays the route. At the request of the user, the store terminal 20 prints and outputs a route guidance map. The printer for issuing receipts normally uses long roll papers. Thus, substantially simplified maps showing the entire route and enlarged guidance maps (so-called rally maps) are sequentially printed on a receipt in the longitudinal direction. In particular, if maps showing guidance intersections are sequentially printed along the route to the destination, the user can refer to one guidance map after another. If the user does not need any of the maps, he or she can discard them. It is also preferable to perforate the maps so that they can be easily separated from one another.

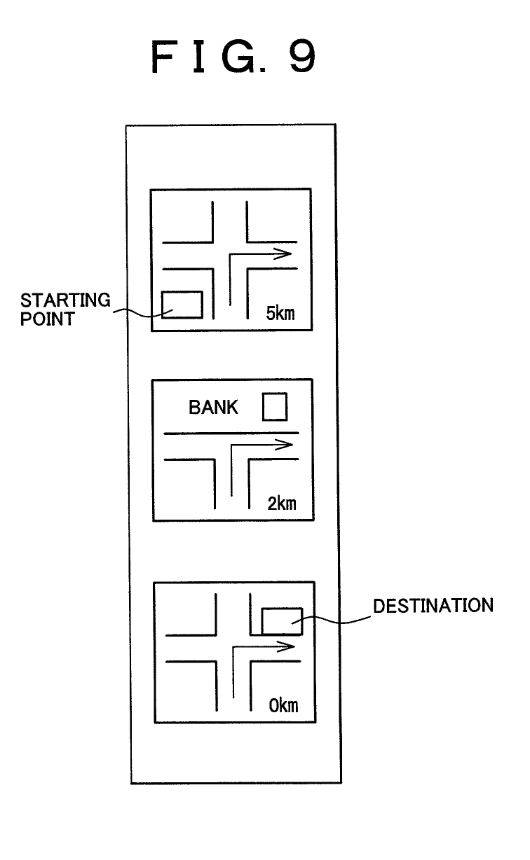

For example, as shown in FIG. 8, the entire route is displayed as the search result. A button for displaying a rally map is displayed at this moment. If this button has been operated, enlarged maps of guidance intersections along the route as shown in FIG. 9 are sequentially displayed, printed and output.

In the respective rally maps wherein the traveling direction coincides with the upward direction, guidance of the traveling direction, the distance to the destination, landmarks (e.g. banks, post offices and the like) are indicated.

Thus, the user can pick up the printed result and continue his or her traveling while referring to it. In particular, it is preferable that the store terminal issue a receipt with a printed search result in the same manner as the sale of an article. Thereby it becomes possible to sequentially print maps of a plurality of guidance intersections for making right and left turns along the longitudinal direction of a long roll paper as shown in FIG. 9.

If the printer for issuing receipts prints rally maps in this manner, the store terminals 20 do not need a printer for printing maps in particular and therefore can be realized as low-priced systems. It is also possible to utilize a printer of a conventional cash register.

Except outputting the travel information by printing a map with the information providing terminal as means for providing the travel information, the information provided by the information providing terminal is stored on a memory medium or transmitted by a communication technology so that the information can be read and displayed on PDA (Personal Digital Assistants) and a navigation system provided with the vehicle.

In the illustrated embodiment, the center server 12 is a controller that is implemented as a programmed general purpose computer. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. A travel information providing center for providing user terminals with travel information, comprising:
a memory that stores information on registered members;
an input/output interface that receives a member ID from a user terminal; and
a controller coupled to the memory and the interface, and that confirms the registered member based on the received member ID and prepares travel information based on the information regarding the registered member stored in the memory upon confirmation that the member is registered.

2. The center according to claim 1, wherein:
the information on the member stored in the memory is the information on a home of the member; and
the home of the member is set as a starting point on a route prepared by the controller as part of the track information.

3. The center according to claim 1, wherein:
the input/output interface receives key information for specifying information requested by the member from the user terminal, and the controller prepares the travel information based on the key information.

4. The center according to claim 1, wherein:
the key information is information on accommodation facilities; and
the controller selects accommodation facilities as part of the travel information to be provided, based on the member information stored in the memory.

5. The center according to claim 3, wherein:
the key information is information on tourist facilities; and
the controller selects tourist facilities as part of the travel information to be provided, based on the member information stored in the memory.

6. The center according to claim 1, wherein:
the input/output interface receives a destination of the user input through the user terminal, and the controller prepares information on a route from a starting point to the destination as part of the travel information to be provided.

7. The center according to claim 6, wherein:
the information on the route includes at least one of information on the entire route and information on particular areas along the route.

8. The center according to claim 1, wherein:
the controller prepares, upon confirmation that the member is registered, the travel information so as to include route information and information on the locations of service providing facilities which are adjacent to the route and which are exclusively available to the member who has been identified based on the member information stored in the memory.

9. The center according to claim 1, further comprising:
a terminal that displays the travel information.

10. The center according to claim 1, further comprising:
a medium that stores the travel information: and
a terminal that reads the travel information stores on the medium and displays the travel information.

11. A travel information providing center for providing user terminals with travel information, comprising:
a memory that stores information on the locations of information providing terminals installed at various locations;
a input/output interface that receives a member ID; and
a controller coupled to the memory and the interface, and that confirms a registered member based on the received member ID, and provides route information as travel information to be provided to a user upon confirmation that the member is registered and provides information on locations of the information providing terminals which are installed adjacent to the route and which are stored in the memory.

12. The center according to claim 11, wherein:
the controller provides information on the location of the information providing terminal that sent the member ID received by the input/output interface.

13. An information providing terminal comprising:
an input device through which a user inputs a member ID of the user; and
a controller that provides detailed information on a vicinity of the information providing terminal upon confirmation that the user is a registered member based on the input member ID.

14. The information providing terminal according to claim 13, wherein:
the information provided by the controller includes at least one of information on the location of the information providing terminal and information on the vicinity of the information providing terminal.

15. An information providing terminal comprising:
an input device through which a user inputs a destination;
a controller that provides route information on a route to the destination in response to the input of the destination, and prepares a junction guidance map showing junctions requiring guidance from the route information; and
a printer that prints the prepared junction guidance map.

16. The terminal according to claim 15, wherein:
the printer is located in a store and issues receipts when selling articles, the printer also output the junction guidance map.

17. The terminal according to claim 15, wherein:
the printer is a roll-paper printer; and
the printer can sequentially print the junction guidance maps in the longitudinal direction of a roll paper.

18. A travel information providing system comprising:
a terminal through which a user inputs a member ID; and
a center having a memory that stores information on registered members and a controller that provides a registered member with travel information based on the member information stored in the memory if it is determined from the member ID input through the terminal that the user is a registered member, wherein:
the terminal displays the travel information provided by the center.

19. A method of providing user terminals with travel information, comprising:
storing information on registered members;
receiving a member ID through an input/output interface from a user terminal;
confirming through a controller that the user is a registered member with a valid member ID; and
preparing travel information based on the information regarding the registered member stored in the memory upon confirmation that the member is registered.

20. A method of providing travel information comprising:
storing information on the locations of information providing terminals installed at various locations;
receiving a member ID through an input/output interface;
confirming a registered member based on the member ID;
providing route information as travel information to a user upon confirmation of the registered member; and
providing information on the locations of the information providing terminals which are installed adjacent to the route.

21. A method of providing travel information comprising:
inputting a member ID through a terminal;
storing information in a center on registered members;
providing a registered member with travel information based on the member information stored in the memory if it is determined from the member ID input through the terminal that the user is a registered member; and
displaying the travel information provided by the center.
